(19) United States
(12) Patent Application Publication
(10) Pub. No.: US 2018/0004779 A1
(43) Pub. Date: Jan. 4, 2018

(54) COMPUTER-BASED SYSTEMS, COMPUTER READABLE STORAGE MEDIA AND COMPUTER-IMPLEMENTED METHODS FACILITATING AUTOMATIC DETERMINATION OF SIZING INFORMATION AND AUTOMATIC SELECTION AND CONFIGURATION OF ONE OR MORE OBJECTS WITHIN CONTAINERS

(71) Applicant: BoxFox, Inc., Whittier, CA (US)

(72) Inventors: Chelsea Moore, Whittier, CA (US); Jennifer Olivero, Half Moon Bay, CA (US); Sabena Suri, Fremont, CA (US)

(21) Appl. No.: 15/637,946

(22) Filed: Jun. 29, 2017

Related U.S. Application Data
(60) Provisional application No. 62/356,331, filed on Jun. 29, 2016.

(51) Int. Cl. G06F 17/30; B65B 61/02; B65B 59/02; B65B 5/02

(52) U.S. Cl. CPC G06F 17/30292; G06F 17/30575; G06F 17/30463; B65B 5/02; B65B 61/02; B65B 59/02; G06F 17/30442

(57) ABSTRACT

This disclosure generally relates to embodiments facilitating automatic determination of sizing information and automatic selection and configuration of one or more objects within containers. A computer-implemented method comprises: determining, by a device comprising a processor, weight information and size information for one or more objects of a plurality of objects for placement in one of a plurality of containers; generating information facilitating selection of a defined container of the plurality of containers based on the weight information and the size information for the one or more objects; displaying via a display screen, a first price associated with a first subset of the one or more objects upon detection of selection of the first subset of the one or more objects; and replacing the first price with a second price, via the display screen based upon detection of a second subset of the one or more objects.

### CROSS-REFERENCE TO RELATED APPLICATIONS

This application claims priority to and the benefit of U.S. Provisional Patent Application No. 62/356,331, filed Jun. 29, 2016 and titled “COMPUTER-BASED SYSTEMS, COMPUTER READABLE STORAGE MEDIA AND METHODS FOR AUTOMATED SELECTION AND DESIGN OF GIFT PACKAGES,” the entirety of which is incorporated herein by reference.

### TECHNICAL FIELD

This disclosure generally relates to computer-implemented methods, computer readable storage media and computer-based systems facilitating automatic determination of sizing information and automatic selection and configuration of one or more objects within containers.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to facilitating a selection of products and fitting such products within sized containers based on a user preference. As used herein, the term “container” can be or include, a box (composed of any material or shape—polygonal, irregular or otherwise), a package (composed of any material or shape—polygonal, irregular or otherwise), a gift box, a gift package, a gift basket or any other mechanism that can hold or receive one or more objects. As used herein, the terms “product,” “object,” “item” and/or “gift” are used interchangeably. As used herein, a “curation” means one or more products/items/objects arranged in a container. For example, a curation can be provided as a gift to a third-party.

In an aspect, disclosed is a non-limiting example embodiment of a computer-implemented method comprising: determining, by a device comprising a processor, weight information and size information for one or more objects of a plurality of objects for placement in one of a plurality of containers; generating information facilitating selection, by the device, of a defined container of the plurality of containers based on the weight information and the size information for the one or more objects; displaying, by the device, via a display screen, a first price associated with a first subset of the one or more objects upon detection of selection of the first subset of the one or more objects; and replacing the first price, by the device, with a second price, via the display screen based upon detection of a second subset of the one or more objects, wherein the second subset is different from the first subset.

In an aspect, disclosed is a non-limiting example embodiment of a computer-based system comprising: a memory that has stored thereon computer executable components; and a processor that executes the following computer executable components stored in the memory: an interface component configured to display a set of searchable products, wherein a subset of searchable products of the set of searchable products are capable of fitting within a set of sized containers; a sorting component configured to organize the set of searchable products based on a set of user criteria; a selection component configured to facilitate a selection of a first subset of searchable products of the set of products based on a user preference; a measuring component configured to identify a first sized container of the set of sized containers capable of fitting the first subset of searchable products within the first sized container; and a presentation component configured to display a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.

In an aspect, disclosed is a non-limiting example embodiment of a computer-readable storage medium storing executable instructions that, in response to execution, cause a device comprising a processor to perform operations, comprising: displaying a set of searchable products, wherein a subset of searchable products of the set of searchable products are capable of fitting within a set of sized containers; organizing the set of searchable products based on a set of user criteria; selecting a first subset of searchable products of the set of products based on a user preference; identifying a first sized container of the set of sized containers capable of fitting the first subset of searchable products within the first sized container; and displaying a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.

In an aspect, disclosed is a non-limiting example embodiment of a system comprising an interface component, a sorting component, a selection component, a measuring component, and a presentation component. In an aspect, an interface component is configured to display a set of searchable products, wherein a subset of searchable products of the set of searchable products are capable of fitting within a set of sized containers. The system is configured to automatically determine and/or select appropriately-sized containers for the selected products.

In another aspect, a sorting component is configured to organize the set of searchable products based on a set of user criteria. Also, a selection component is configured to facilitate a selection of a first subset of searchable products of the set of products based on a user preference. Furthermore, in an aspect, a measuring component is configured to identify a first sized container of the set of sized containers capable of fitting the first subset of searchable products within the first sized container. In yet another aspect, a presentation component is configured to display a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.

Also disclosed is a non-limiting example method of selecting products and fitting the selected products within a sized container based on a user preference. In an aspect, the method comprises displaying, by a system comprising a processor, a set of searchable products, wherein a subset of searchable products of the set of searchable products are capable of fitting within a set of sized containers. Also, the method comprises organizing, by the system, the set of searchable products based on a set of user criteria. Furthermore, in an aspect, the method comprises selecting, by the system, a first subset of searchable products of the set of products based on a user preference.

In another aspect, the method comprises identifying, by the system, a first sized container of the set of sized containers capable of fitting the first subset of searchable products within the first sized container. In yet another aspect, the method further comprises displaying, by the system, a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a non-limiting, example block diagram of an example computer-based system embodiment that can facilitate automated selection and configuration of one or more objects within containers in one or more embodiments;

FIG. 2 illustrates a non-limiting, example block diagram of an example computer-based system embodiment that can facilitate automated selection and configuration of one or more objects within containers in one or more embodiments;

FIG. 3 illustrates a non-limiting, example block diagram of an example computer-based system embodiment that can facilitate automated selection and configuration of one or more objects within containers in one or more embodiments;

FIG. 4 illustrates a non-limiting, example block diagram of an example computer-based system embodiment that can facilitate automated selection and configuration of one or more objects within containers in one or more embodiments;

FIGS. 5 and 6A illustrate non-limiting, example block diagrams of example computer-based system embodiments that can facilitate automated selection and configuration of one or more objects within containers in one or more embodiments;

FIG. 6B-6H illustrate non-limiting, example flow diagrams of computer-implemented methods that can facilitate automated selection and configuration of one or more objects within containers in one or more embodiments; and

FIGS. 7-9 illustrate example schematic block diagrams for computing environments in accordance with certain embodiments of this disclosure.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing this disclosure.

In implementations, the components described herein can perform actions, in real-time, near real-time, online and/or offline. Online/offline can refer to states identifying connectivity between one or more components. In general, “online” indicates a state of connectivity, while “offline” indicates a disconnected state. In an aspect, offline merging can prevent service interruptions, end-user quality degradation, and the like.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other. It is noted that while media items are referred to herein, the systems and methods of this disclosure can utilize other content items.

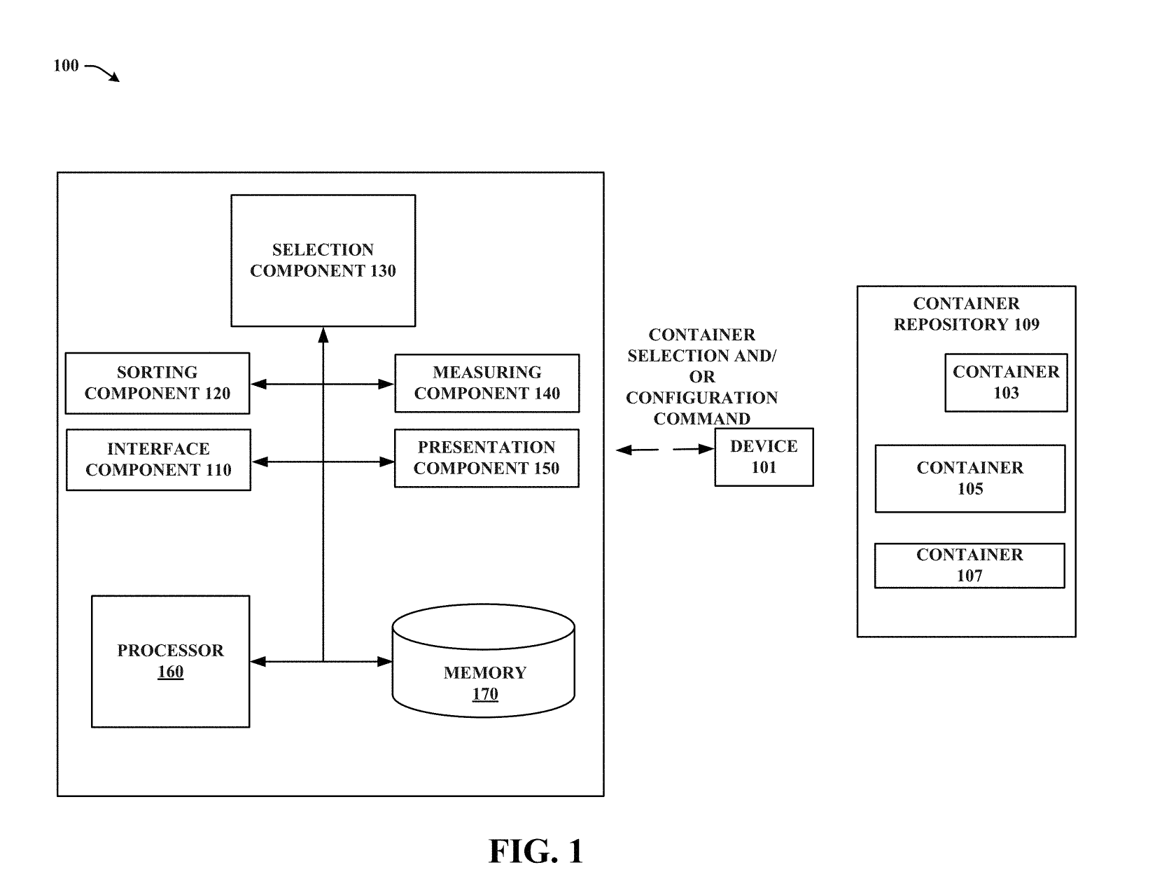

Referring now to FIG. 1, presented is an example computer-based system 100 configured to facilitate automated selection and configuration of one or more objects within containers in one or more embodiments. The various components of system 100 and other systems described herein can be connected either directly or indirectly to one or more networks. In an aspect, computer-based system 100 can comprise interface component 110, sorting component 120, selection component 130, measuring component 140, and presentation component 150. In various embodiments, one or more of interface component 110, sorting component 120, selection component 130, measuring component 140, and/or presentation component 150 can be electrically and/or communicatively coupled to one another to perform one or more functions of computer-based system 100. In some embodiments, the system 100 can be communicatively and/or electrically coupled to device 101 that can receive a container selection and/or configuration command from system 100 and select and/or configure one or more of physical containers 103, 105, 107 located in container repository 109. In some embodiments, the container repository can be a warehouse or other storage facility or location. In some embodiments, the container repository can also include one or more products/objects (not shown) for inclusion in the container.

In an aspect, computer-based system 100 can further comprise a processor 160 and can also include memory 170 that stores computer executable components, and a processor 160 executes the computer executable components stored in the memory 170. For example, an interface component employed by system 100 can be stored in memory 170 and can be executed (e.g., using processor 160) to display (e.g., via a display screen of a mobile or fixed device) images of a set of searchable products. In some embodiments, a subset of the searchable products are capable of fitting within a set of sized containers. In an aspect, disclosed is a platform that can receive input from another device. In some embodiments, the device can be controlled by a user, although such is not necessary (e.g., a user or customer can generate an input to a device that can communicate with the computer-based system 100) to execute by processor 160 searching at an interface (e.g., using interface component 110) and sorting (e.g., using sorting component 120) through a wide array of products based on different reasons to shop, various product themes, prices, and colors. For instance, processor 160 can execute sorting tasks associated with the products based on a type of event (e.g., birthday, bridal, celebration, new mom, housewarming, etc.), person (e.g., men, women), or theme (e.g., essentials, hostess, just cause, new products, thanks, library, treats, unwind, etc.).

The system 100 can also receive and process user input in order for presentation component 150 to display (e.g., via a display screen of a mobile or fixed device) a list of products and an appropriately sized container starting point based on the received user input. For instance, presentation component 150 can display (e.g., via a display screen of a mobile or fixed device) an empty container and fill the container with images of products based on selected products (e.g., using selection component 130). As items are added to the container based on received user selection input (e.g., using selection component 130), presentation component 150 displays (e.g., via a display screen of a mobile or fixed device) the selected items filling the container and the price of the container filled with such items.

Accordingly, the presentation component 150 can display (e.g., via a display screen of a mobile or fixed device) an empty container and subsequent views of the container being filled over time with products. The display of products and/or the price can be updated as each object is either added to the container or removed from the container. In various embodiments, presentation component 150 provides the capability of adding or removing different products easily in multiple locations and/or webpage displayed as the system processes an order. For example, in some embodiments, an icon associated with each individual product listing being displayed can be activated and that icon can then add the product or remove the product from the set of products to be included in the container. In some embodiments the system can add a cost of the items and a base fee that can be associated with the service provided by the system for ease of ordering and the like.

The measuring component 140 can track the quantity of one or more specific item that have been added to the box/container by the system 100.. In some embodiments, the system 100 can also add up and/or subtract in the container display on both the image and text listing that can be displayed. The presentation component 150 can also provide drag and drop functionality such that the text line or the image can be dragged or selected by a user of the presentation component 150 /or by the system and the image can be dragged and/or moved around to different locations on the display. Accordingly, if there is a particular set of objects (e.g., a candle, a phone case and a pen), images of these objects can be moved around on the display to place the different items next to each other to help the user better organize the items being curated in the container. Accordingly, the system 100 can enable the re-ordering of both the text and/or description of an item displayed as well as any images, to facilitate user shopping and/or organization of item on the display screen by color, theme, price or otherwise.

In some embodiments, for each container that can be selected, a volume is assigned. For example, for a container that is a 10″×8″×4″ box, a volume is assigned of total value “13”. When new products are added to the container, the system can evaluate the volume and assign the volume of the product being added a value between “1” and “13.” In some embodiments, the total products placed in the container cannot exceed the total volume value assigned to the container (or, in some embodiments, a container associated with a larger value than “13” can be selected). In some embodiments, the system can provide an option of ordering a smaller or larger container (or requesting products be placed in a smaller or larger container or a smaller or larger container than that selected by the system). In some embodiments, volume will determine the vessel selected for shipment of the container.

The system 100 can also execute measurement tasks (e.g., using measuring component 140) and is capable of outputting measurement information. In one or more embodiment, for example, the measurement tasks can include, but are not limited to, measuring the selected products, and determining a container of appropriate dimensions to fit the number and types of products selected by selection component 130. The measurement of one or more selected products and/or the selection of the container and/or dimensions of the container can be measurement information in some embodiments. In some embodiments, the measurement tasks can also include, but are not limited to, calculating a price based on the selected products. In some embodiments, the measuring component 140 can, in real-time, add items and/or remove items and display updated total price. Thus, the system 100 by employing measuring component 140 can measure an assortment of products for fit within a range of container sizes. Furthermore, system 100 can list and present (e.g., using presentation component 150) photos and prices associated with the appropriately sized container in an easy to read format.

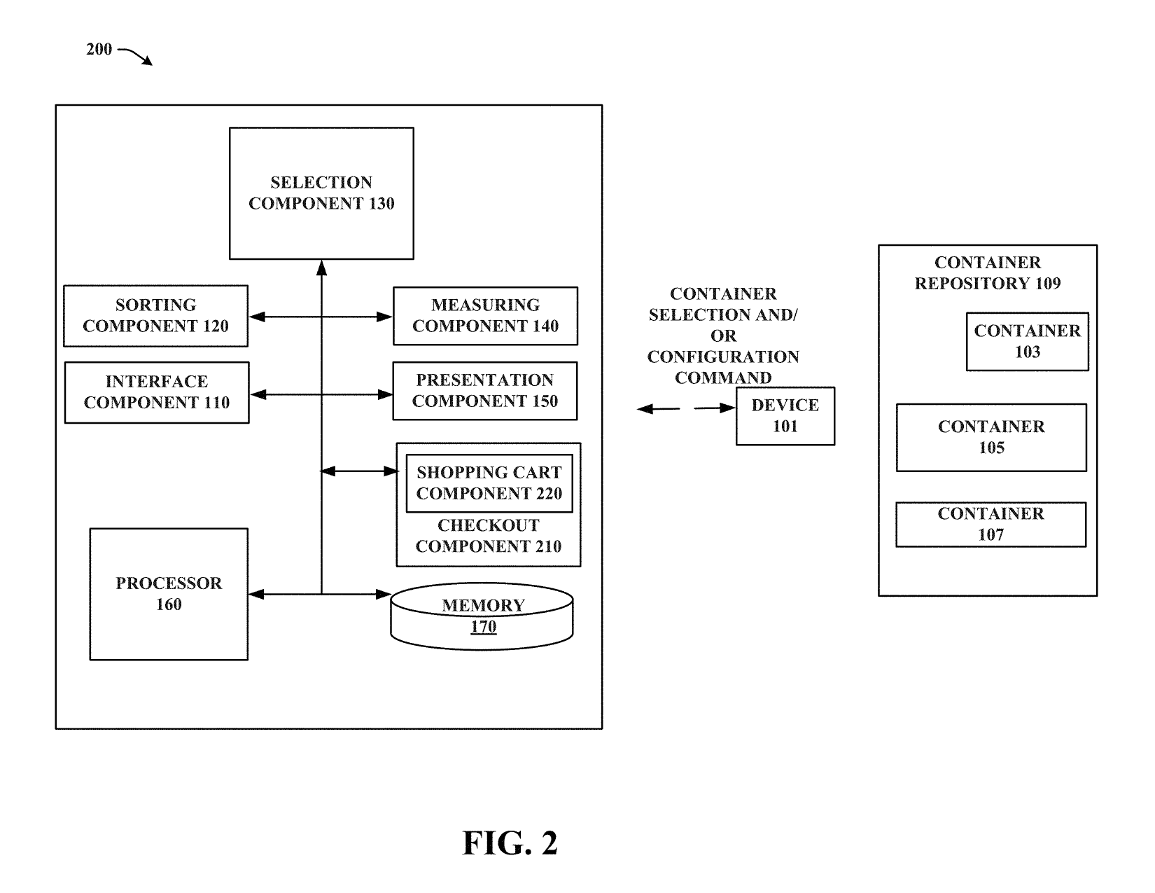

Referring to FIG. 2, illustrated is non-limiting example system 200 configured to facilitate selection of products and fitting such packages in a container. Repetitive description of like elements employed in one or more embodiments described herein is omitted for sake of brevity.

System 200 can comprise interface component 110, sorting component 120, selection component 130, measuring component 140, and presentation component 150. System 200 can further comprise checkout component 210 configured to facilitate a purchase of the first subset of searchable products, wherein the checkout component 210 employs shopping cart component 220 to conduct at least one of a set of tasks comprising a capability to continue purchasing additional products to add to the first subset of searchable products, add a second subset of searchable products fitting within another sized container for purchase, or complete a purchase of the first subset of searchable products based on receipt of user input by system 200.

Upon completing the custom container using system 200 using checkout component 210, shopping cart component 220 in connection with presentation component 150 can display options to choose a desired card and write a note. Furthermore, shopping cart component 220 can add the created container to the cart, remove the container from the cart, build another container or, in connection with checkout component 210, checkout and pay for the container and associated items.

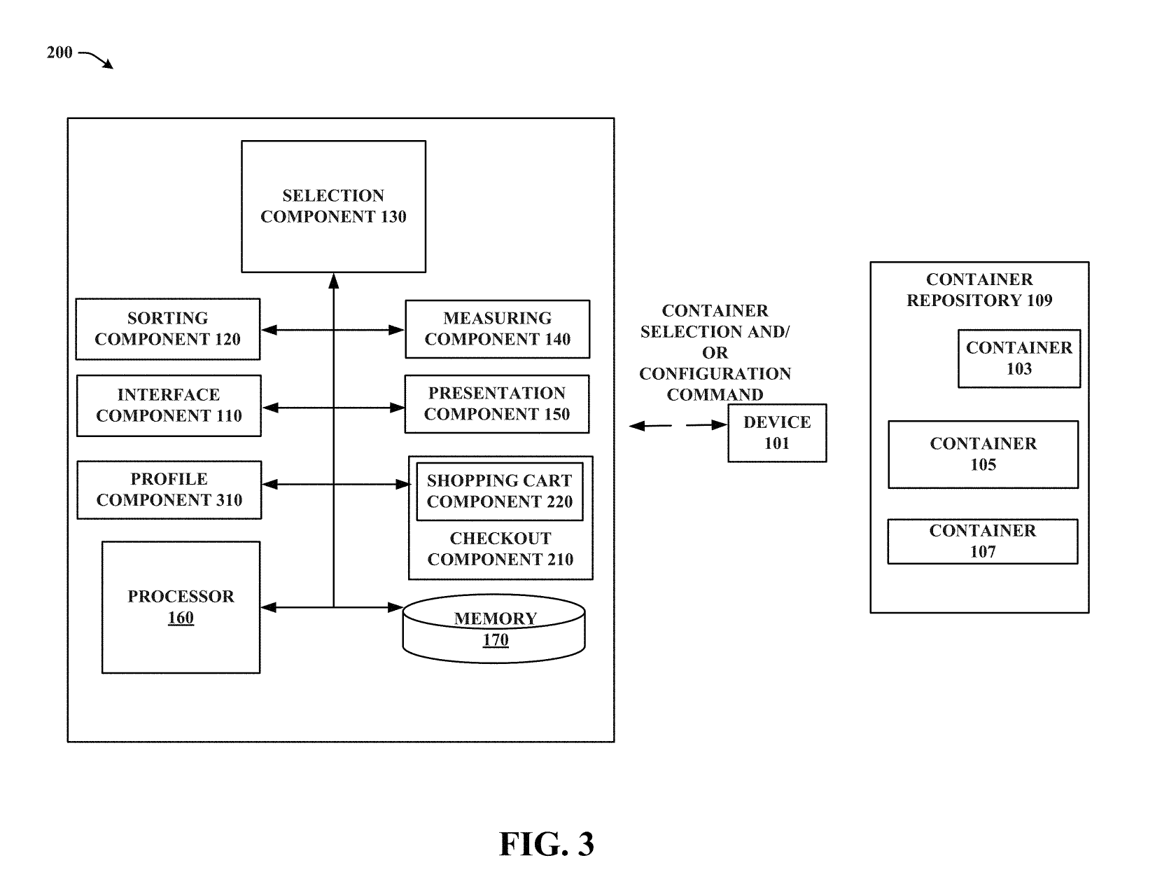

Referring now to FIG. 3, illustrated is a non-limiting example system 300 configured to facilitate selection of products and fitting such packages in a container. Repetitive description of like elements employed in one or more embodiments described herein is omitted for sake of brevity.

System 300 can comprise interface component 110, sorting component 120, selection component 130, measuring component 140, and presentation component 150, and checkout component 210. Furthermore, in an aspect, system 300 can employ profile component 310 configured to access historical purchase information associated with previous product purchases of the set of searchable products.

In an aspect, system 300 can receive user input from users such as corporate clients and based on the received user input profile component 310 in connection with presentation component 150 can display user login data and facilitate the building profile-associated gifts without the need for constant attention or building gifts from scratch for each purchase. The profile component 310 can create or access an existing profile that stores historical information such as previous containers, products, cards, and other items sent to previous recipients based on currently or previously received user input. Thus, system 300 serves as a touch point management tool to help ease the process of creating and sending gifts based on received user input. For instance, a corporation may need to send multiple gifts continually for business development purposes, as such, by sending data to system 300, profile component 310 can create a profile and utilize purchase information associated with the corporation's inputted data to help the corporation streamline the recurring gift giving process, save time as well as save money.

Accordingly, profile component 310 can store one or more curations previously created by a corporation or other entity (e.g., individual person or business entity). The curation can be stored as a “product,” which can be accessed later by the same entity upon the entity logging into the system. In some embodiments, the presentation component 150 can display a link via webpage URL for quick re-order of the “product.”

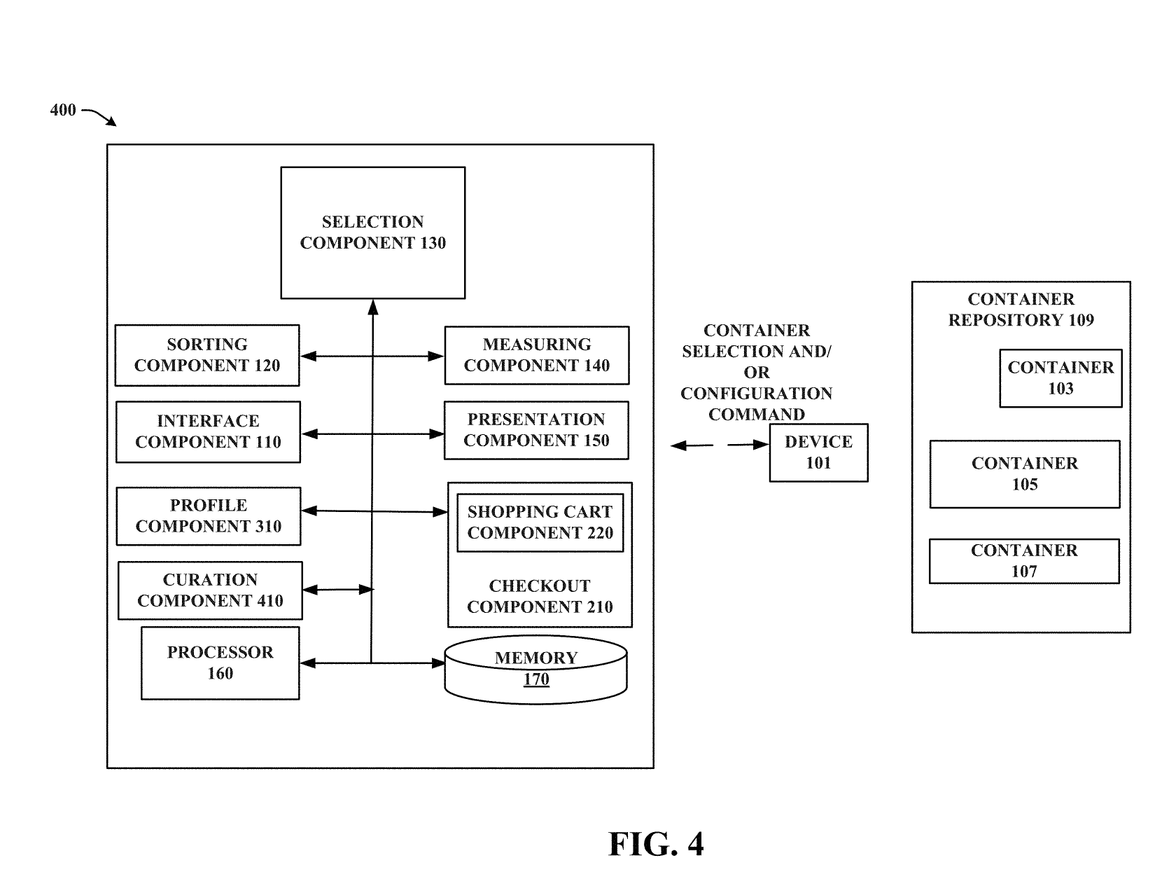

Referring now to FIG. 4, illustrated is non-limiting example system 400 configured to facilitate selection of products and fitting such packages in a container. Repetitive description of like elements employed in one or more embodiments described herein is omitted for sake of brevity.

System 400 can comprise interface component 110, sorting component 120, selection component 130, measuring component 140, and presentation component 150, checkout component 210, and profile component 310. System 400 can further employ curation component 410 configured to facilitate a curation of a range of product types comprising at least one of candy items, clothing items, or designer drugstore items. For example, system 400 can be configured to have a number of different categorization options, as well as a “shop all” option (which can be accessed via an icon). The different categorization options for system 400 can include, but is not limited to, color, shape, size, weight, theme, use, reason for gifting and price. The categorization of items can be provided by the system 400 for all listings of products output by the presentation component 150. Via the “shop all” option the system 400 can enable reset of the display of text and/or images of products and view of all images as opposed to view of only particular items that fit into a defined category (e.g., all items can be shown as opposed to say items that are blue, which have been categorized by color).

In an aspect, system 400 can provide employ curation component 410 to curate a number of items for gifting such as candy, care packages, clothing bundles and e-commerce. As such, system 400 is capable of providing a marketplace where the building of a container can be used as more than a gift giving tool but also as a tool to curate (e.g., using curation component 410) different types of products for consumption. As such, system 400 can receive input data from partnering users and display products associated with such partner input data to allow for the selection (e.g., using selection component 130) and automatic determination (e.g., using measuring component 140) of appropriately sized containers for selected partner products.

This system process can foster partnerships between various product companies and brands and implore them to use system 400 to execute the listing (e.g., using presentation component 150) of its partner products on the platform for users to consume. Such products can include, candy stores, clothing bundles, designer drugstore items, and other such verticals. For example, the system 400 can organize products in a backend system in collections or with similar tags (e.g., virtual tags) to encourage product pairings based on use together/functionality etc. For example, the system can merchandise new mom-related products by creating information indicative of a collection of mom-related products. Within this grouping, if a particular product goes well with another product, those two products can be associated or tagged with one another so that if one of the two products is selected or being considered or reviewed by a user (e.g., the presentation component 150 is displaying the item for review or placing the item in a designated location on the display screen after selection), the system will suggest the other product. As such, both products can be listed together when the customer shops for “mom” or “pamper/relax” or “heal”. Another example is small bowls. Small bowls can be associated by the system 400 with our charcoal face masks, because the use of the bowls is suitable for mixing the face mask. As such, the system 400 can tag the two products to associate them with one another. Accordingly, the system 400 can tag products based on use, theme or other relations.

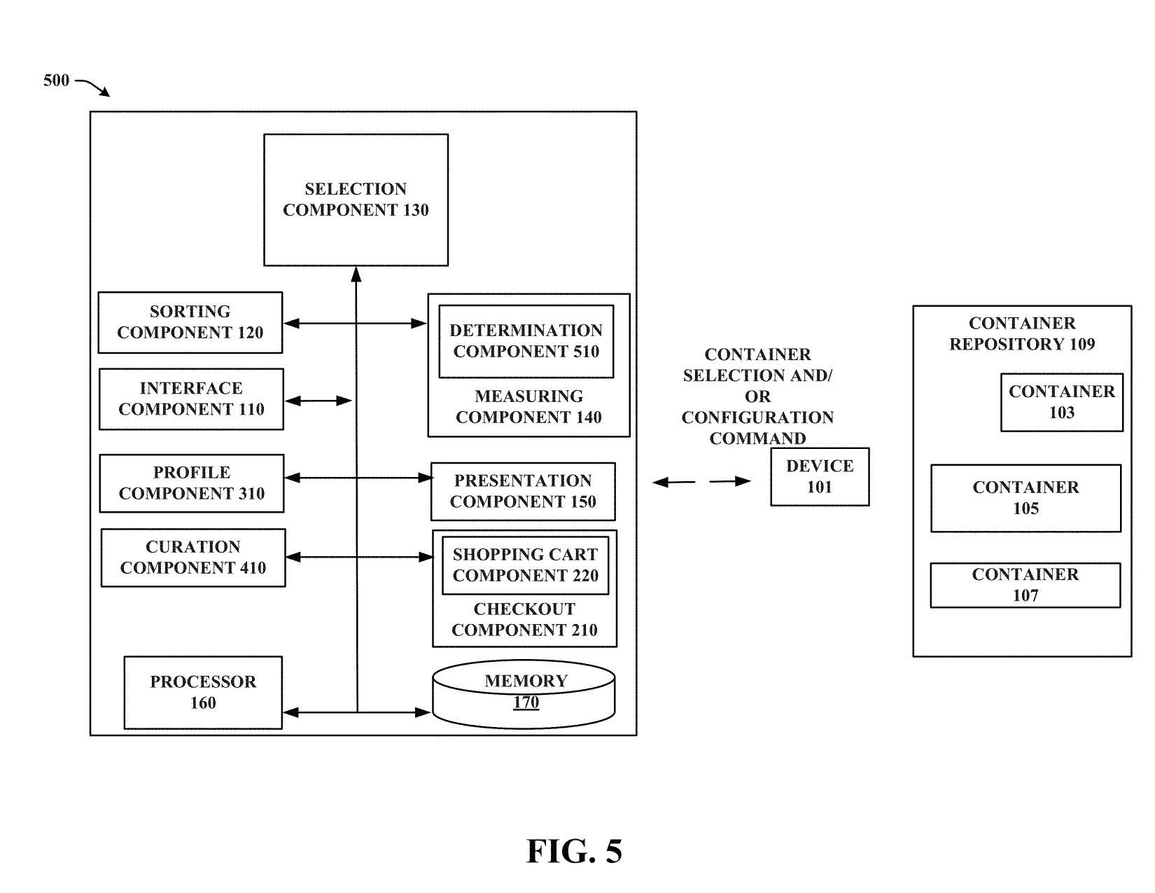

Referring now to FIG. 5, illustrated is non-limiting example system 500 configured to facilitate selection of products and fitting such packages in a container. Repetitive description of like elements employed in one or more embodiments described herein is omitted for sake of brevity.

System 500 can comprise interface component 110, sorting component 120, selection component 130, measuring component 140, and presentation component 150, checkout component 210, profile component 310, and curation component 410 configured to facilitate a curation of a range of product types comprising at least one of candy items, clothing items, or designer drugstore items. Furthermore, system 500 can comprise measuring component 140 that further employs determination component 510 configured to determine a fit of the first sized container to the first subset of searchable products based on a weight of the first subset of searchable products and a corresponding value associated with the weight.

In an aspect, the fit of selected products within a container can be determined (e.g., using determination component 510) by calculating an associated weight of each selected product and an aggregate weight of the total selected products. Each product weight corresponds with a numeric value associated with dimensions that are stored within system 500 (E.g., at a database). Thus, determination component 510 inhibits the over packing of containers by determining the weight and dimensions of the products that fit within given sized containers. Thus, when selection component 130 add products for purchase, determination component 510 uses the weights to determine whether a large or small container should be used to house the products.

Accordingly, determination component 510 in connection with shopping cart component 220 can facilitate the segmenting of specific curations within a shopping cart from different recipients.

In some embodiments, the system can facilitate a loyalty program where a user can input data and/or preferences and the system will execute an algorithm that triggers outputted reminder emails based on that information, calendar reminders for birthdays, other occasions (e.g., anniversaries).

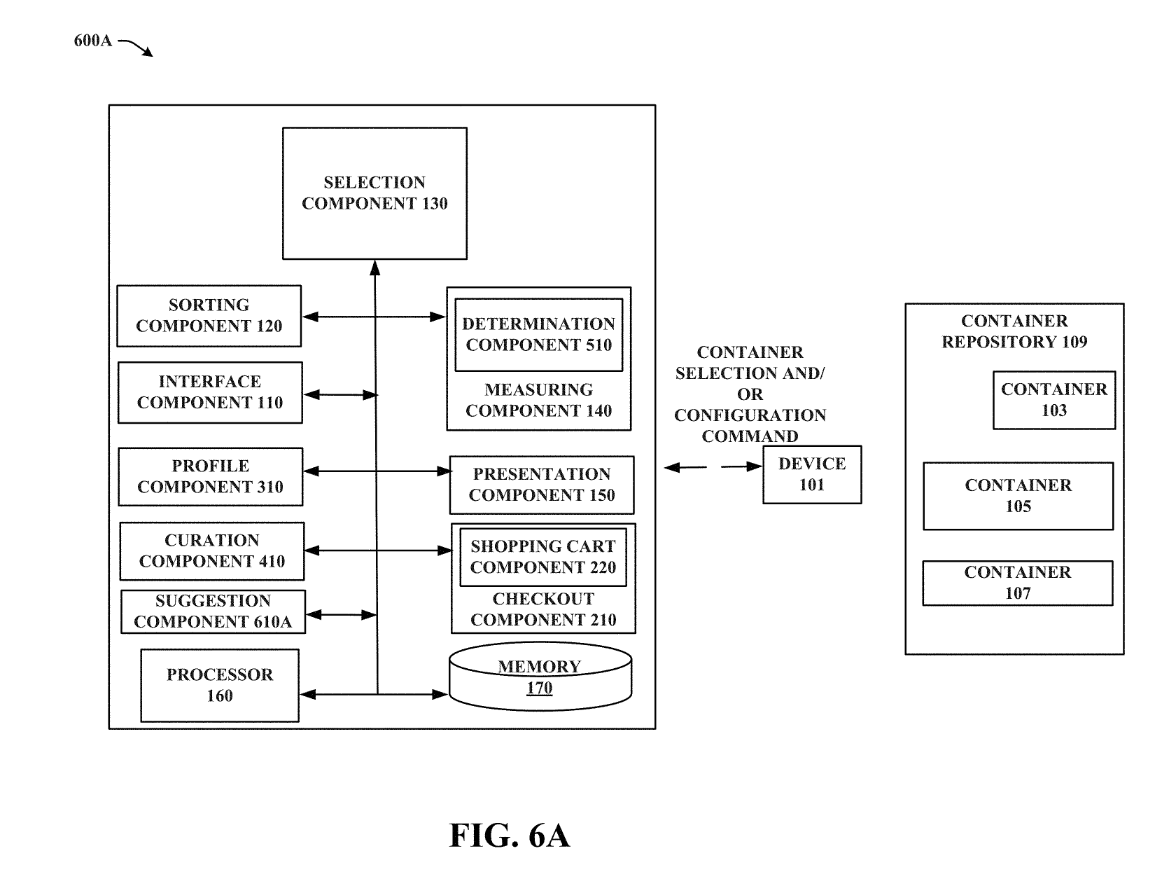

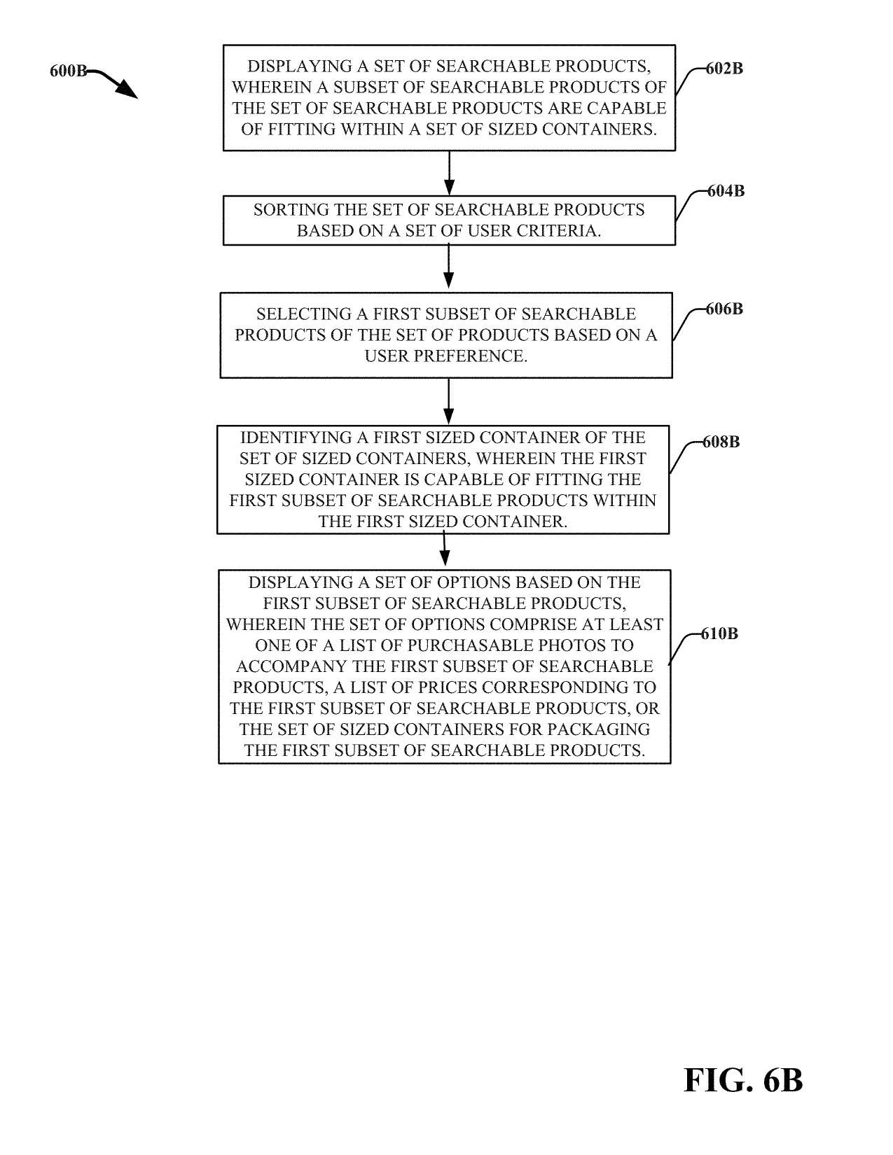

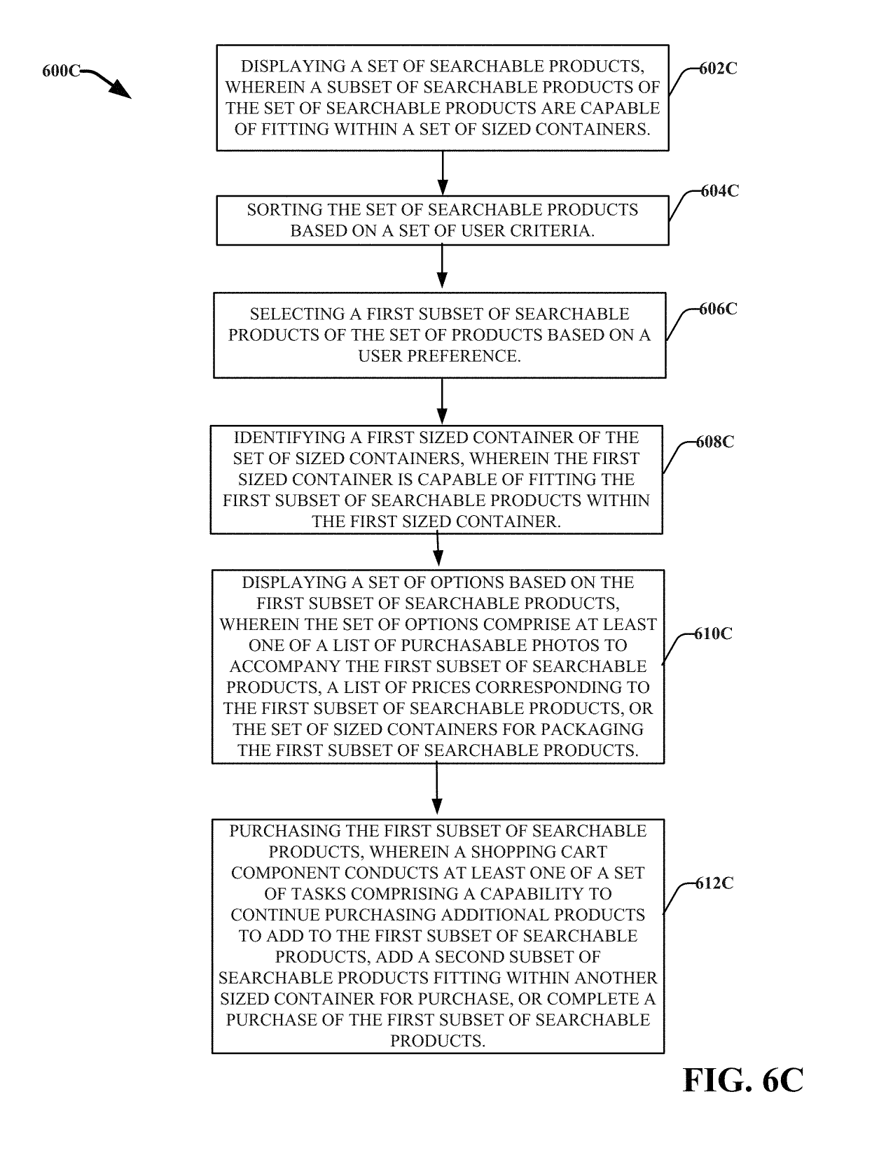

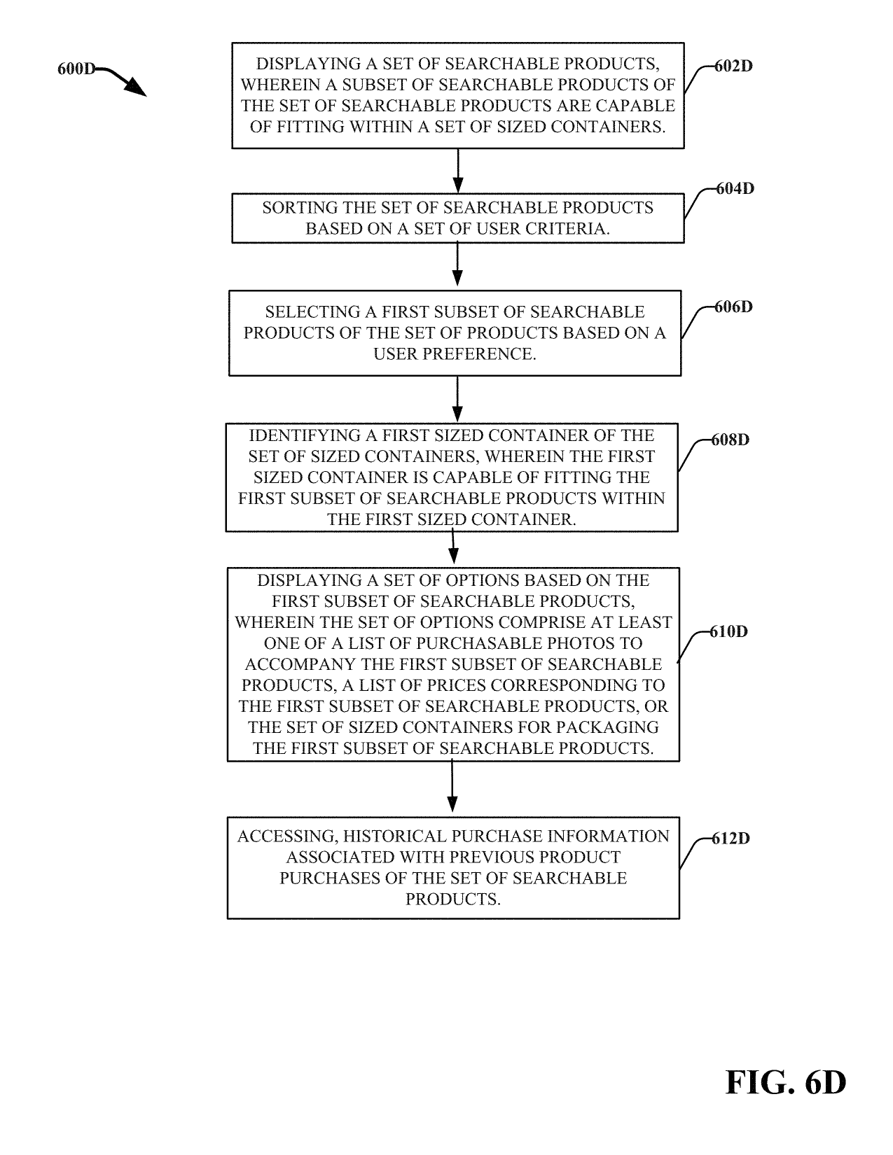

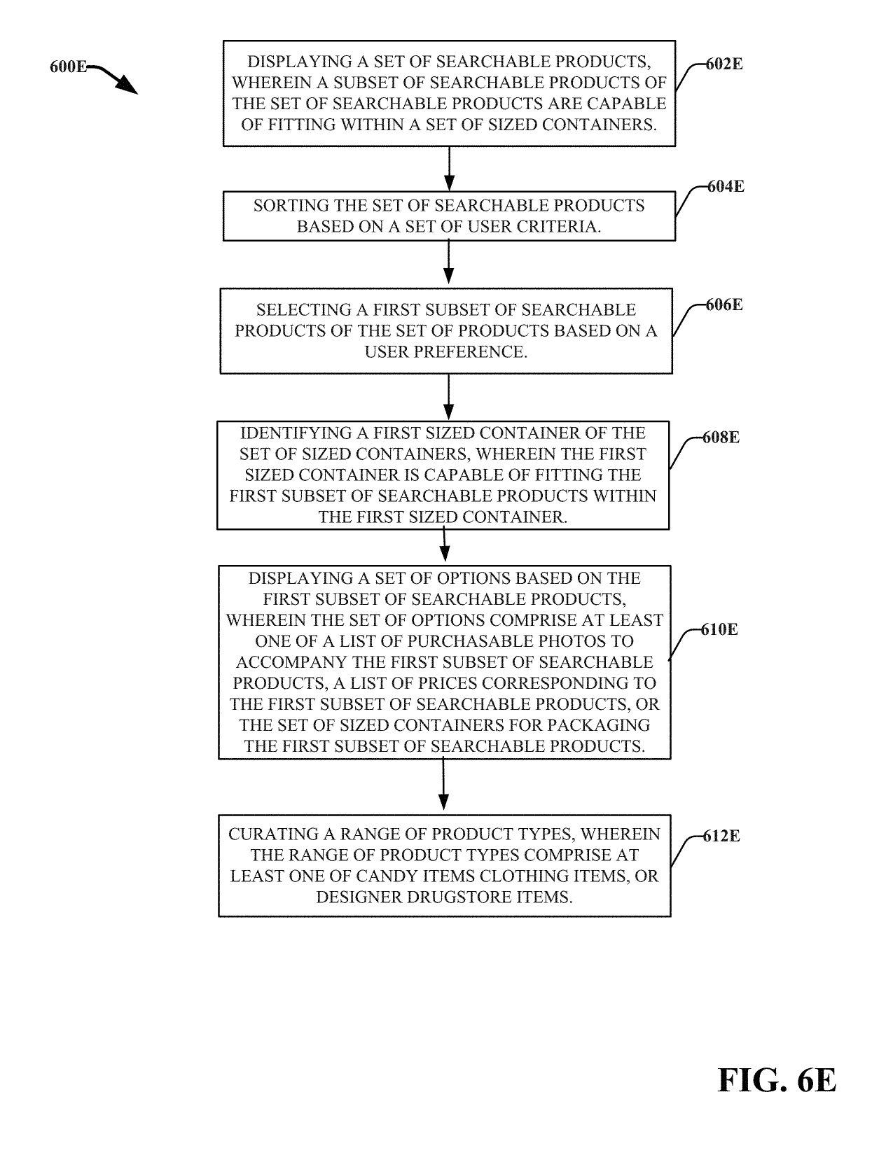

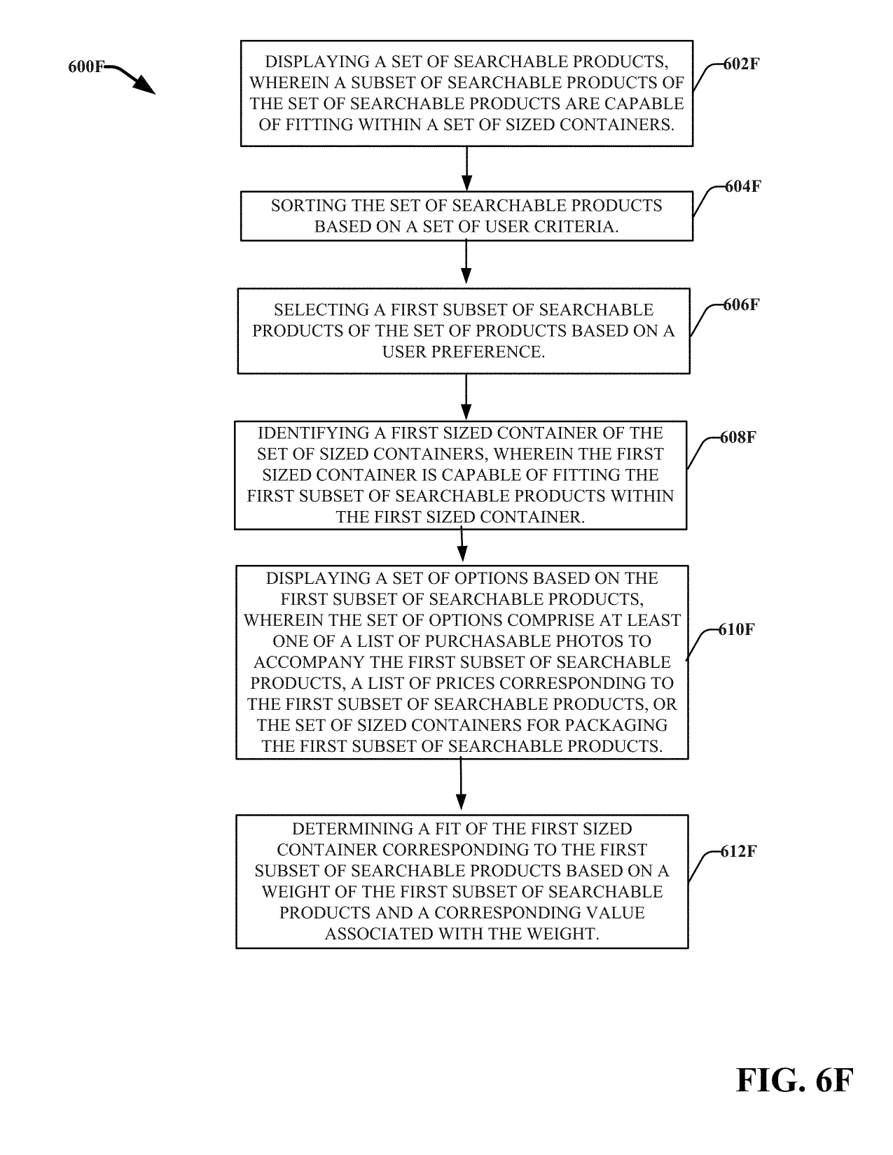

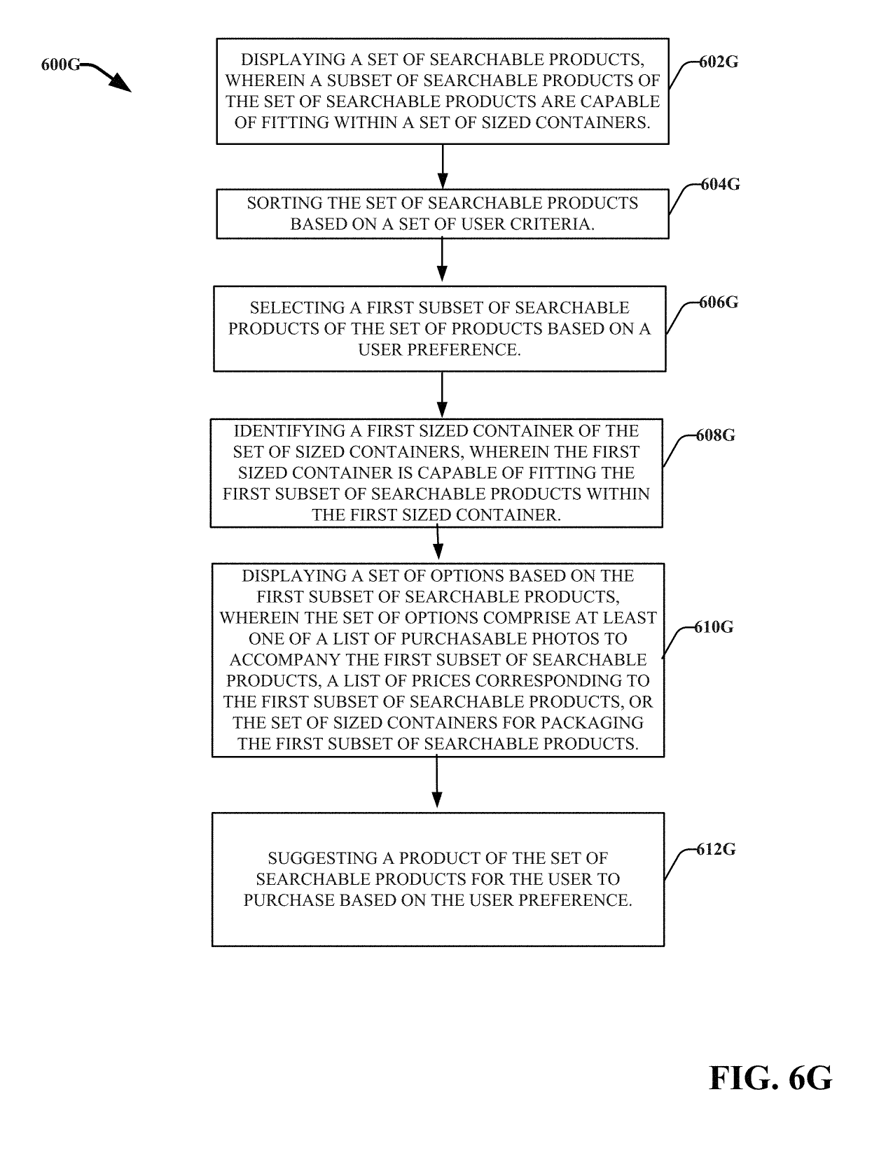

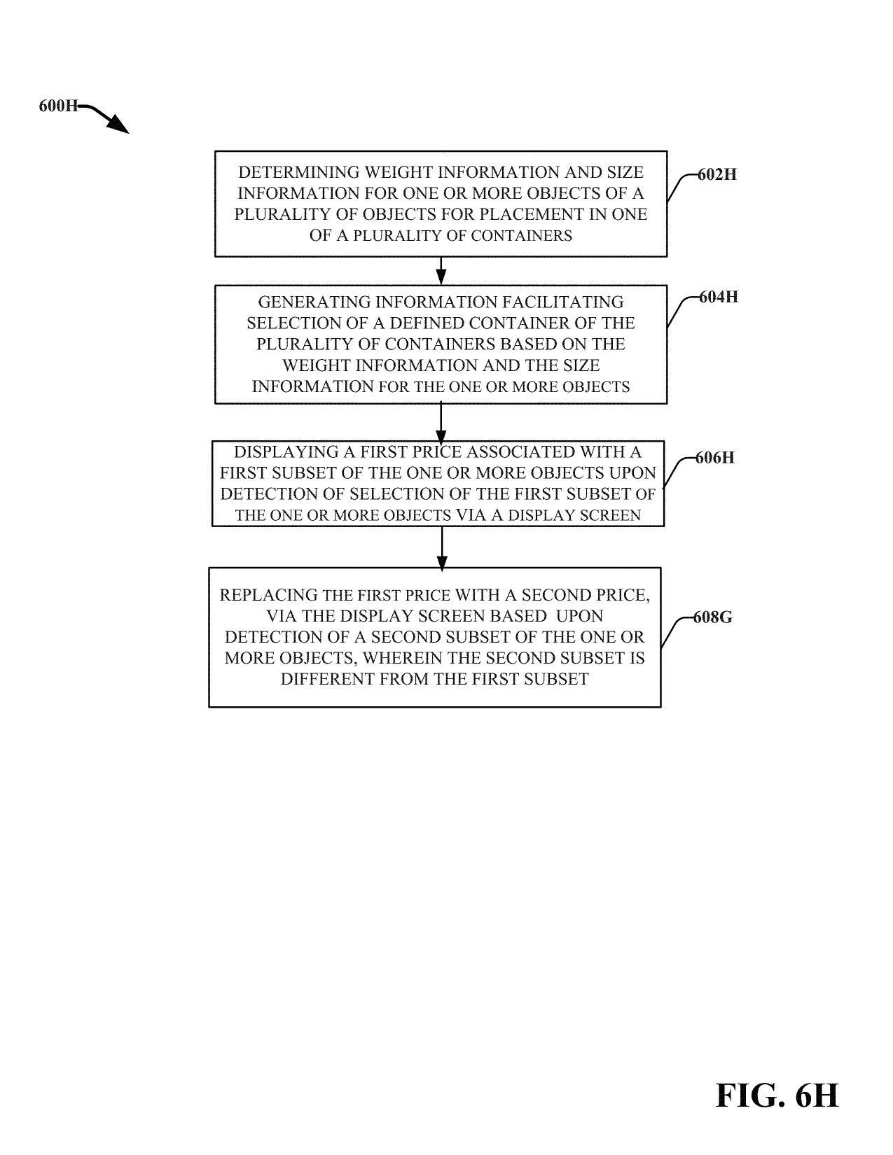

Referring now to FIG. 6A, illustrated is non-limiting example system 600A configured to facilitate selection of products and fitting such packages in a container. Repetitive description of like elements employed in one or more embodiments described herein is omitted for sake of brevity.

System 600A can comprise interface component 110, sorting component 120, selection component 130, measuring component 140, and presentation component 150, checkout component 210, profile component 310, curation component 410, and determination component 510. In another aspect, system 600A can employ suggestion component 610A configured to suggest a product of the set of searchable products for the user to purchase based on the user preference. In an aspect, suggestion component 610A can make suggestions for products to select based on a remaining physical space in the package, the type of products already selected, and based on the occasion for which products are selected.

In another aspect, system 600A can execute container building tasks from the ground up and accordingly adjust the price as the container is being built. The system 600A can also employ toggles to allow the products to be organized and displayed (e.g., using presentation component 150) by price, occasion, or other such product attribute. In another aspect, the containers can also be styled in accordance with a user preference (e.g., based on received user input data) such as containers styled to be open with a product facing out (e.g., resembling a gift basket style).

In another aspect, system 600A can provide recommendation of delivery dates, suggested delivery timelines based on the content data associated with the selected products to be delivered in the containers (e.g., foods with perishability concerns, etc.). For example, there is a tagging capablity in the backend portion of the system where, if a particular product is selected (e.g., a perishable product) for inclusion in a container by a user, when the user is purchasing (e.g., checking out at a virtual shopping cart online), a pop up or other notification can be provided by the system to the user (or displayed by the system presentation component 150) that notifies the user of the shelf life of the product and/or provides a suggested expedited shipping to the user address (as opposed to regular shipping). In another embodiment, the user can be provided options for shipping delivery times and a suggestion can be indicated via presentation component that one or more shipping methods/delivery times are preferred (e.g., due to perishability or otherwise).

In yet another aspect, system 600A can execute tasks that allow for automatically recurring gifts to be delivered to a desired recipient based on a desired schedule.

In some embodiments, the system can generate recommendations for additional products for inclusion in a container based on remaining physical space in container and/or occasion for which the product/object in the container is selected. In some embodiments, based on the weight of each product/object/item already in the container, the system can suggest additional products before or after user moves on to purchase the items in the virtual shopping cart based on remaining space.

In some embodiments, the system can have and/or display a favorites section at which a user can build multiple containers from a “favorites” section and add straight to virtual shopping cart The favorites can be shown and/or accessed upon user login in some embodiments.

In some embodiments of systems 100, 200, 300, 400, 500, 600, a physical action can occur as a result of the determinations made. For example, a physical container (e.g., device 101 of FIGS. 1, 2, 3, 4, 5, and 6A) can be selected from a location of storage and/or retrieved by a device/machine (not shown) communicatively coupled to one of the systems described herein. In some embodiments, the device can receive a command from the system and process such command thereby being activated to select and/or retrieve the particular container. In some embodiments, the output of one or more of the systems can cause the device/machine to select and/or configure the products in the container in a particular arrangement.

In various embodiments, embodiments described herein can be utilized to perform any of the methods and execute any of the system components described herein. The systems 100, 200, 300, 400, 500, 600A and/or the components of the system 100 can be employed to use hardware and/or software to solve problems that are highly technical in nature (e.g., related to automated mathematical sizing for different containers and products, mathematical sizing for automated curation, which provides for efficiency due to the endless number of possible arrangements of placement of objects as well as alignment of objects along different x, y and/or z axes). One or more embodiments can maximize efficiency and enable for scale. Other problems that are solved that are highly technical in nature include, but are not limited to, determination of container sizes appropriate for selected products, etc.), that are not abstract and that cannot be performed as a set of mental acts by a human. Further, some of the processes performed may be performed by specialized computers for carrying out defined tasks related to the automated mathematical container sizing application/subject area, evaluation of objects based on weight and determination of appropriate containers based on weight, and the like. The systems 100-600A and/or components of the systems can be employed to solve new problems that arise through advancements in technology, computer networks, the Internet and the like. The systems 100-600A can provide technical improvements to sizing packages associated with assorted products by improving processing efficiency among processing components in an automated package sizing system, allowing for an appropriately sized container to be determined in association with a selection of an assortment of goods based on user data input, improving shipping processes by reducing the likelihood of returned or damaged packages and products and the like.

Further, the rise of the Internet has provided for numerous capabilities that are beyond those that could be accommodated prior to the Internet. For example, the Internet enables the business model described herein to exist because users can now send gifts and care packages in a manner that is anonymous and trustworthy. Before the internet, a call center could possibly take orders over the phone but considering the urgency of most gifting occasions, which is one of the needs addressed in this application, the business would not be sustainable because short deadlines could not be met. Consumers would not be able to order. Now, with the advent of the Internet, users can curate with visual information being provided, ship, and track their packages via the Internet. In terms of scalability and efficiency, one or more of the embodiments described herein streamline a process that normally would take one person more than a whole day to complete. One or more embodiments can be performed in near-real-time and/or real-time including, but not limited to, visual presentation of dynamically changing inventory of products, receipt of selections by users, determination of container sizing, selection and/or configuration of one or more products in the container and/or shipment.

In some embodiments, a physical action can occur as a result of the determinations made. For example, a physical container can be selected from a location of storage and/or retrieved by a device/machine (not shown) communicatively coupled to one of the systems described herein. In some embodiments, the device can receive a command from the system and process such command thereby being activated to select and/or retrieve the particular container. In some embodiments, the output of one or more of the systems can cause the device/machine to select and/or configure the products in the container in a particular arrangement.

In view of the example systems/interfaces described herein, example methods that can be implemented in accordance with the disclosed subject matter can be further appreciated with reference to flowcharts in FIG. 6B-6H. Repetitive description of like elements employed in one or more embodiments described herein is omitted for sake of brevity.

For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 6B illustrates a flow chart of an example method 600B for facilitating selection of products and fitting such products in a container. At 602B, a set of searchable products is displayed (e.g., using interface component 110), wherein a subset of searchable products of the set of searchable products are capable of fitting within a set of sized containers. At 604B, the set of searchable products are sorted (e.g., using sorting component 120) based on a set of user criteria. At 606B, a first subset of searchable products of the set of products are selected based on a user preference. At 608B, a first sized container of the set of sized containers is identified (e.g., using measuring component 140), wherein the first sized container is capable of fitting the first subset of searchable products within the first sized container. At 610B, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products.

FIG. 6C illustrates a flow chart of an example method 600C for facilitating selection of products and fitting such products in a container. At 602C, a set of searchable products is displayed (e.g., using interface component 110), wherein a subset of searchable products of the set of searchable products are capable of fitting within a set of sized containers. At 604C, the set of searchable products are sorted (e.g., using sorting component 120) based on a set of user criteria. At 606C, a first subset of searchable products of the set of products are selected based on a user preference. At 608C a first sized container of the set of sized containers is identified (e.g., using measuring component 140), wherein the first sized container is capable of fitting the first subset of searchable products within the first sized container. At 610C, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products. At 612C, the first subset of searchable products is purchased (e.g., using checkout component 210), wherein a shopping cart component 220 conducts at least one of a set of tasks comprising a capability to continue purchasing additional products to add to the first subset of searchable products, add a second subset of searchable products fitting within another sized container for purchase, or complete a purchase of the first subset of searchable products

FIG. 6D illustrates a flow chart of an example method 600D for facilitating selection of products and fitting such products in a container. At 602D, a set of searchable products is displayed (e.g., using interface component 110), wherein a subset of searchable products of the set of searchable products are capable of fitting within a set of sized containers. At 604D, the set of searchable products are sorted (e.g., using sorting component 120) based on a set of user criteria. At 606D, a first subset of searchable products of the set of products are selected based on a user preference. At 608D a first sized container of the set of sized containers is identified (e.g., using measuring component 140), wherein the first sized container is capable of fitting the first subset of searchable products within the first sized container. At 610D, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products. At 612D, historical purchase information is accessed (e.g., using profile component 310) associated with previous product purchases of the set of searchable products.

FIG. 6E illustrates a flow chart of an example method 600E for facilitating selection of products and fitting such products in a container. At 602E, a set of searchable products is displayed (e.g., using interface component 110), wherein a subset of searchable products of the set of searchable products are capable of fitting within a set of sized containers. At 604E, the set of searchable products are sorted (e.g., using sorting component 120) based on a set of user criteria. At 606E, a first subset of searchable products of the set of products are selected based on a user preference. At 608E a first sized container of the set of sized containers is identified (e.g., using measuring component 140), wherein the first sized container is capable of fitting the first subset of searchable products within the first sized container. At 610E, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products. At 612E, a range of product types are curated (e.g., using curation component 410), wherein the range of product types comprise at least one of candy items, clothing items, or designer drugstore items.

FIG. 6F illustrates a flow chart of an example method 600F for facilitating selection of products and fitting such products in a container. At 602F, a set of searchable products is displayed (e.g., using interface component 110), wherein a subset of searchable products of the set of searchable products are capable of fitting within a set of sized containers. At 604F, the set of searchable products are sorted (e.g., using sorting component 120) based on a set of user criteria. At 606F, a first subset of searchable products of the set of products are selected based on a user preference. At 608F a first sized container of the set of sized containers is identified (e.g., using measuring component 140), wherein the first sized container is capable of fitting the first subset of searchable products within the first sized container. At 610F, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products. At 612F, a fit of the first sized container is determined (e.g., using measuring component 140 in connection with determination component 510) corresponding to the first subset of searchable products based on a weight of the first subset of searchable products and a corresponding value associated with the weight.

FIG. 6G illustrates a flow chart of an example method 600G for facilitating selection of products and fitting such products in a container. At 602G, a set of searchable products is displayed (e.g., using interface component 110), wherein a subset of searchable products of the set of searchable products are capable of fitting within a set of sized containers. At 604G, the set of searchable products are sorted (e.g., using sorting component 120) based on a set of user criteria. At 606G, a first subset of searchable products of the set of products are selected based on a user preference. At 608G a first sized container of the set of sized containers is identified (e.g., using measuring component 140), wherein the first sized container is capable of fitting the first subset of searchable products within the first sized container. At 610G, a set of options based on the first subset of searchable products are displayed, wherein the set of options comprise at least one of a list of purchasable photos to accompany the first subset of searchable products, a list of prices corresponding to the first subset of searchable products, or the set of sized containers for packaging the first subset of searchable products. At 612G, a product of the set of searchable products is suggested (e.g., using suggestion component 610A) for the user to purchase based on the user preference.

FIG. 6H illustrates a flow chart of an example method 600H for facilitating selection of products and fitting such products in a container. At 602H, weight information and size information for one or more objects of a plurality of objects for placement in one of a plurality of containers are determined. At 604H, information facilitating selection of a defined container of the plurality of containers based on the weight information and the size information for the one or more objects is generated. At 606H, a first price associated with a first subset of the one or more objects upon detection of selection of the first subset of the one or more objects is displayed via a display screen. At 608H, the first price is replaced with a second price, via the display screen based upon detection of a second subset of the one or more objects, wherein the second subset is different from the first subset.

In some embodiments, although not shown, the method can also comprise transmitting, by the device, a command received by a device and causing the device to select the defined container, wherein the plurality of containers are located in a container repository.

In some embodiments, although not shown, the method can also comprise receiving, by the device, notification of a login of an entity; and retrieving, by the device, a profile associated with and based on login by the entity, wherein the profile is associated with at least one previously-selected configuration of the one or more objects by the entity. The determining can be based on the previously-selected configuration of the one or more objects by the entity. In some embodiments, although not shown, the method can also comprise displaying, by the device, an executable webpage link via the display screen and based on the profile, wherein selection of the one or more objects is performed upon activation of the executable webpage link.

In some embodiments, although not shown, the method can also comprise categorizing, by the device, the one or more objects and displaying the categorized one or more objects via the display screen based on at least one of : color, shape, size, weight, theme or use associated with the one or more objects.

In some embodiments, although not shown, the method can also comprise associating, by the device, a subset of the plurality of objects with one another in a group based on a defined characteristic of the subset of the plurality of objects; and displaying, by the device, a recommendation of a first item in the subset based on determination that a second item in the subset is selected as one of the one or more objects of the plurality of objects for placement in one of the plurality of containers.

In some embodiments, although not shown, the method can also comprise receiving, by the device, a signal indicative of a request to move text or an image for at least one of the one or more objects from a first location of the display screen to a second location of the display screen, wherein the signal is received based on user input at a second device external to the device; removing display, by the device of the text or the image from the first location; and displaying, by the device, the text or the image at the second location.

In some embodiments, although not shown, the method can also comprise generating a recommendation, by the device, for defined containeranother object for inclusion in the defined container, wherein the generating is based on a remaining space in the defined container once the one or more objects are placed in the container. In some embodiments, the generating is further based on an occasion for which the one or more objects are selected.

In some embodiments, the generating is further based on a purchase history of a user that selected the one or more objects. In some embodiments, the generating is further based on a use for the one or more objects.

It is understood that the specific components (and measurements thereof) that are disclosed are mere examples. Based upon design preferences, it is understood that the components and/or processes can be rearranged, substituted and/or replaced for components or processes similar in structure and/or function while remaining within the scope of the present disclosure.

Those of skill would further appreciate that the various illustrative modules and functions described in connection with the embodiments disclosed herein can be implemented as electronic hardware, computer software, or combinations of both. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The previous description of the disclosed embodiments is provided to enable any person skilled in the art to make or use the present disclosure. Various modifications to these embodiments will be readily apparent to those skilled in the art, and the generic principles defined herein can be applied to other embodiments without departing from the spirit or scope of the disclosure. Thus, the present disclosure is not intended to be limited to the embodiments shown herein but is to be accorded the widest scope consistent with the principles and novel features disclosed herein.

While the specification describes particular examples of the present invention, those of ordinary skill can devise variations of the present invention without departing from the inventive concept. For example, the teachings herein refer to circuit-switched network elements but are equally applicable to packet-switched domain network elements.

The previous description of the disclosed examples is provided to enable any person skilled in the art to make or use the present invention. Various modifications to these examples will be readily apparent to those skilled in the art, and the generic principles defined herein can be applied to other examples without departing from the spirit or scope of the invention. Thus, the present invention is not intended to be limited to the examples shown herein but is to be accorded the widest scope consistent with the principles and novel features disclosed herein.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

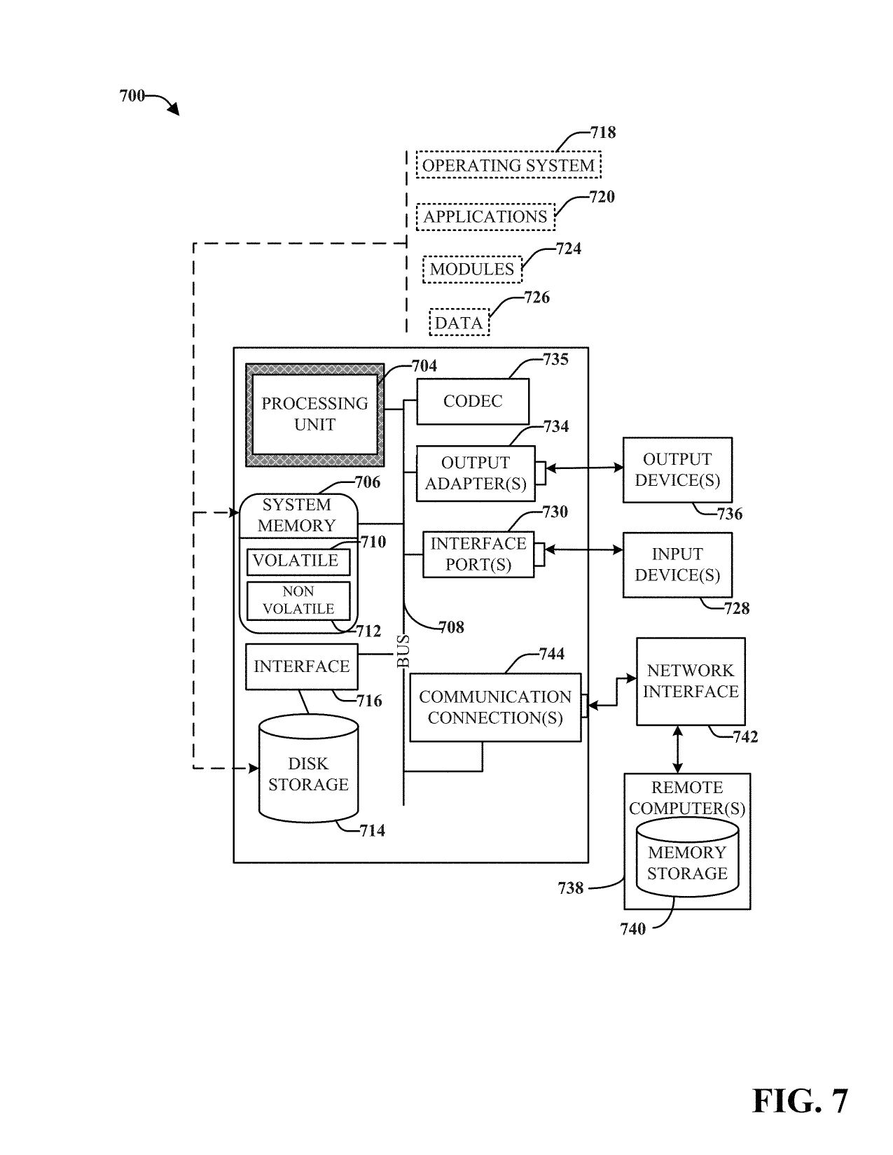

With reference to FIG. 7, a suitable environment 700 for implementing various aspects of the claimed subject matter includes a computer 702. The computer 702 includes a processing unit 704, a system memory 706, a codec 705, and a system bus 708. The system bus 708 couples system components including, but not limited to, the system memory 706 to the processing unit 704. The processing unit 704 can be any of various available processors. Dual microprocessors and other multiprocessor architectures also can be employed as the processing unit 704.

The system bus 708 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 706 includes volatile memory 710 and non-volatile memory 712. The basic input/output system (BIOS), containing the basic routines to transfer information between elements within the computer 702, such as during start-up, is stored in non-volatile memory 712. In addition, according to present innovations, codec 705 may include at least one of an encoder or decoder, wherein the at least one of an encoder or decoder may consist of hardware, a combination of hardware and software, or software. Although, codec 705 is depicted as a separate component, codec 705 may be contained within non-volatile memory 712. By way of illustration, and not limitation, non-volatile memory 712 can include read only memory (ROM), programmable ROM (PROM), electrically programmable ROM (EPROM), electrically erasable programmable ROM (EEPROM), or flash memory. Volatile memory 710 includes random access memory (RAM), which acts as external cache memory. According to present aspects, the volatile memory may store the write operation retry logic (not shown in FIG. 7) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 702 may also include removable/non-removable, volatile/non-volatile computer storage medium. FIG. 7 illustrates, for example, disk storage 714. Disk storage 714 includes, but is not limited to, devices like a magnetic disk drive, solid state disk (SSD) floppy disk drive, tape drive, Jaz drive, Zip drive, LS-70 drive, flash memory card, or memory stick. In addition, disk storage 714 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 714 to the system bus 708, a removable or non-removable interface is typically used, such as interface 716.

It is to be appreciated that FIG. 7 describes software that acts as an intermediary between users and the basic computer resources described in the suitable operating environment 700. Such software includes an operating system 718. Operating system 718, which can be stored on disk storage 714, acts to control and allocate resources of the computer system 702. Applications 720 take advantage of the management of resources by operating system 718 through program modules 724, and program data 726, such as the boot/shutdown transaction table and the like, stored either in system memory 706 or on disk storage 714. It is to be appreciated that the claimed subject matter can be implemented with various operating systems or combinations of operating systems.

A user enters commands or information into the computer 702 through input device(s) 728. Input devices 728 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 704 through the system bus 708 via interface port(s) 730. Interface port(s) 730 include, for example, a serial port, a parallel port, a game port, and a universal serial bus (USB). Output device(s) 736 use some of the same type of ports as input device(s). Thus, for example, a USB port may be used to provide input to computer 702, and to output information from computer 702 to an output device 736. Output adapter 734 is provided to illustrate that there are some output devices 736 like monitors, speakers, and printers, among other output devices 736, which require special adapters. The output adapters 734 include, by way of illustration and not limitation, video and sound cards that provide a means of connection between the output device 736 and the system bus 708. It should be noted that other devices and/or systems of devices provide both input and output capabilities such as remote computer(s) 738.

Computer 702 can operate in a networked environment using logical connections to one or more remote computers, such as remote computer(s) 738. The remote computer(s) 738 can be a personal computer, a server, a router, a network PC, a workstation, a microprocessor based appliance, a peer device, a smart phone, a tablet, or other network node, and typically includes many of the elements described relative to computer 702. For purposes of brevity, only a memory storage device 740 is illustrated with remote computer(s) 738. Remote computer(s) 738 is logically connected to computer 702 through a network interface 742 and then connected via communication connection(s) 744. Network interface 742 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 744 refers to the hardware/software employed to connect the network interface 742 to the bus 708. While communication connection 744 is shown for illustrative clarity inside computer 702, it can also be external to computer 702. The hardware/software necessary for connection to the network interface 742 includes, for exemplary purposes only, internal and external technologies such as, modems including regular telephone grade modems, cable modems and DSL modems, ISDN adapters, and wired and wireless Ethernet cards, hubs, and routers.

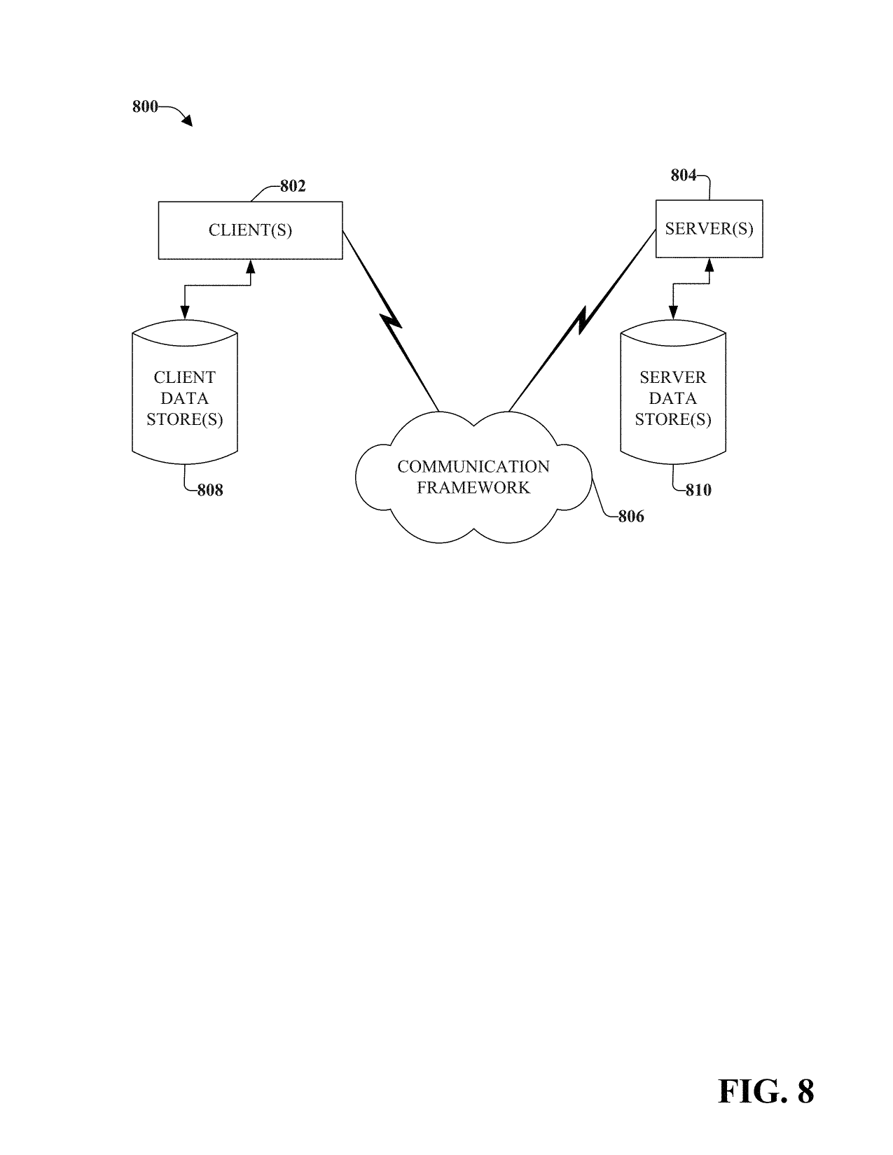

Referring now to FIG. 8, there is illustrated a schematic block diagram of a computing environment 800 in accordance with this disclosure. The system 800 includes one or more client(s) 802 (e.g., laptops, smart phones, PDAs, media players, computers, portable electronic devices, tablets, and the like). The client(s) 802 can be hardware and/or software (e.g., threads, processes, computing devices). The system 800 also includes one or more server(s) 804. The server(s) 804 can also be hardware or hardware in combination with software (e.g., threads, processes, computing devices). The servers 804 can house threads to perform transformations by employing aspects of this disclosure, for example. One possible communication between a client 802 and a server 804 can be in the form of a data packet transmitted between two or more computer processes wherein the data packet may include video data. The data packet can include a metadata, e.g., associated contextual information, for example. The system 800 includes a communication framework 806 (e.g., a global communication network such as the Internet, or mobile network(s)) that can be employed to facilitate communications between the client(s) 802 and the server(s) 804.

Communications can be facilitated via a wired (including optical fiber) and/or wireless technology. The client(s) 802 include or are operatively connected to one or more client data store(s) 808 that can be employed to store information local to the client(s) 802 (e.g., associated contextual information). Similarly, the server(s) 804 are operatively include or are operatively connected to one or more server data store(s) 810 that can be employed to store information local to the servers 804.

In one embodiment, a client 802 can transfer an encoded file, in accordance with the disclosed subject matter, to server 804. Server 804 can store the file, decode the file, or transmit the file to another client 802. It is to be appreciated, that a client 802 can also transfer uncompressed file to a server 804 and server 804 can compress the file in accordance with the disclosed subject matter. Likewise, server 804 can encode video information and transmit the information via communication framework 806 to one or more clients 802.

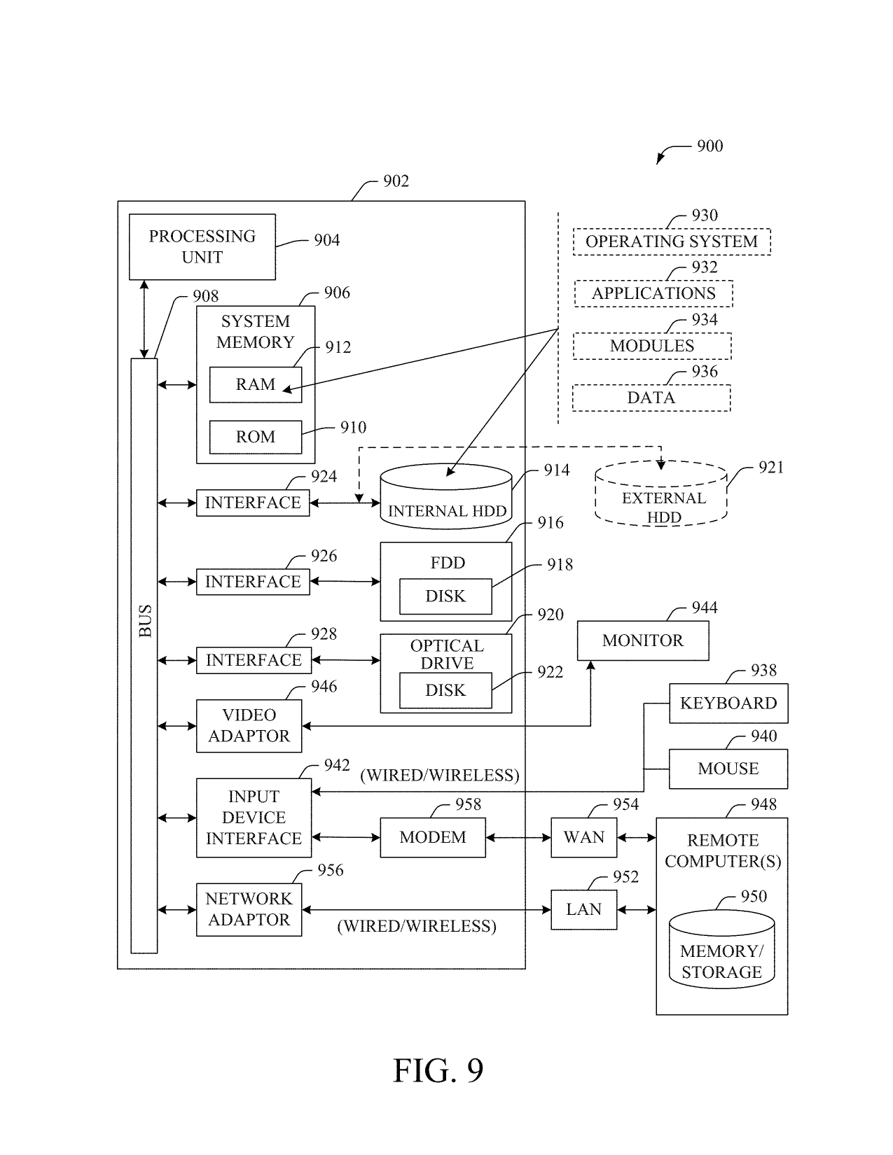

FIG. 9 illustrates a block diagram of a computer that can be employed in accordance with one or more embodiments. Repetitive description of like elements employed in other embodiments described herein is omitted for sake of brevity. In some embodiments, the computer, or a component of the computer, can be or be comprised within any number of components described herein comprising, but not limited to, sorting component 120, interface component 110, selection component 130, measuring component 140, presentation component 150, shopping cart component 220, checkout component 210, profile component 310, curation component 410, determination component 510, suggestion component 610A (or a component of sorting component 120, interface component 110, selection component 130, measuring component 140, presentation component 150, shopping cart component 220, checkout component 210, profile component 310, curation component 410, determination component 510, suggestion component 610A).

In order to provide additional text for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable (or machine-readable) storage media and/or communications media, which two terms are used herein differently from one another as follows. Computer-readable (or machine-readable) storage media can be any available storage media that can be accessed by the computer (or a machine, device or apparatus) and comprises both volatile and nonvolatile media, removable and non-removable media. By way of example, and not limitation, computer-readable (or machine-readable) storage media can be implemented in connection with any method or technology for storage of information such as computer-readable (or machine-readable) instructions, program modules, structured data or unstructured data. Tangible and/or non-transitory computer-readable (or machine-readable) storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable (or machine-readable) storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable (or machine-readable) media, is to be understood to exclude only propagating intangible signals per se as a modifier and does not relinquish coverage of all standard storage, memory or computer-readable (or machine-readable) media that are not only propagating intangible signals per se.

In this regard, the term “non-transitory” herein as applied to storage, memory or computer-readable (or machine-readable) media, is to be understood to exclude only propagating transitory signals per se as a modifier and does not relinquish coverage of all standard storage, memory or computer-readable (or machine-readable) media that are not only propagating transitory signals per se.

Communications media typically embody computer-readable (or machine-readable) instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 9, the example environment 900 for implementing various embodiments of the embodiments described herein comprises a computer 902, the computer 902 comprising a processing unit 904, a system memory 906 and a system bus 908. The system bus 908 couples system components comprising, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 comprises ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also comprise a high-speed RAM such as static RAM for caching data.

The computer 902 further comprises an internal hard disk drive (HDD) 910 (e.g., EIDE, SATA), which internal hard disk drive 914 can also be configured for external use in a suitable chassis (not shown), a magnetic floppy disk drive 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface, respectively. The interface 924 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable (or machine-readable) storage media provide nonvolatile storage of data, data structures, computer-executable instructions, and so forth. For the computer 902, the drives and storage media accommodate the storage of any data in a suitable digital format. Although the description of computer-readable (or machine-readable) storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 912, comprising an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

A communication device can enter commands and information into the computer 902 through one or more wired/wireless input devices, e.g., a keyboard 938 and a pointing device, such as a mouse 940. Other input devices (not shown) can comprise a microphone, an infrared (IR) remote control, a joystick, a game pad, a stylus pen, touch screen or the like. These and other input devices are often connected to the processing unit 904 through an input device interface 942 that can be coupled to the system bus 908, but can be connected by other interfaces, such as a parallel port, an IEEE 1394 serial port, a game port, a universal serial bus (USB) port, an IR interface, etc.

A monitor 944 or other type of display device can be also connected to the system bus 908 via an interface, such as a video adapter 946. In addition to the monitor 944, a computer typically comprises other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically comprises many or all of the elements described relative to the computer 902, although, for purposes of brevity, only a memory/storage device 950 is illustrated. The logical connections depicted comprise wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 952 through a wired and/or wireless communication network interface or adapter 956. The adapter 956 can facilitate wired or wireless communication to the LAN 952, which can also comprise a wireless AP disposed thereon for communicating with the wireless adapter 956.

When used in a WAN networking environment, the computer 902 can comprise a modem 958 or can be connected to a communications server on the WAN 954 or has other means for establishing communications over the WAN 954, such as by way of the Internet. The modem 958, which can be internal or external and a wired or wireless device, can be connected to the system bus 908 via the input device interface 942. In a networked environment, program modules depicted relative to the computer 902 or portions thereof, can be stored in the remote memory/storage device 950. It will be appreciated that the network connections shown are example and other means of establishing a communications link between the computers can be used.

The computer 902 can be operable to communicate with any wireless devices or entities operatively disposed in wireless communication, e.g., a printer, scanner, desktop and/or portable computer, portable data assistant, communications satellite, any piece of equipment or location associated with a wireles sly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x =(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a communication device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing communication device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of communication device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable (or machine-readable) storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above comprises mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A computer-implemented method, comprising:
determining, by a device comprising a processor, weight information and size information for one or more objects of a plurality of objects for placement in one of a plurality of containers;
generating information facilitating selection, by the device, of a defined container of the plurality of containers based on the weight information and the size information for the one or more objects;
displaying, by the device, via a display screen, a first price associated with a first subset of the one or more objects upon detection of selection of the first subset of the one or more objects; and
replacing the first price, by the device, with a second price, via the display screen based upon detection of a second subset of the one or more objects, wherein the second subset is different from the first subset.

2. The computer-implemented method of claim 1, further comprising:
transmitting, by the device, a command received by a device and causing the device to select the defined container, wherein the plurality of containers are located in a container repository.

3. The computer-implemented method of claim 1, further comprising:
receiving, by the device, notification of a login of an entity; and
retrieving, by the device, a profile associated with and based on login by the entity, wherein the profile is associated with at least one previously-selected configuration of the one or more objects by the entity.

4. The computer-implemented method of claim 3, wherein the determining is based on the previously-selected configuration of the one or more objects by the entity.

5. The computer-implemented method of claim 3, further comprising:
displaying, by the device, an executable webpage link via the display screen and based on the profile, wherein selection of the one or more objects is performed upon activation of the executable webpage link.

6. The computer-implemented method of claim 1, further comprising:
categorizing, by the device, the one or more objects and displaying the categorized one or more objects via the display screen based on at least one of : color, shape, size, weight, theme or use associated with the one or more objects.

7. The computer-implemented method of claim 1, further comprising:
associating, by the device, a subset of the plurality of objects with one another in a group based on a defined characteristic of the subset of the plurality of objects; and
displaying, by the device, a recommendation of a first item in the subset based on determination that a second item in the subset is selected as one of the one or more objects of the plurality of objects for placement in one of the plurality of containers.

8. The computer-implemented method of claim 1, further comprising:
receiving, by the device, a signal indicative of a request to move text or an image for at least one of the one or more objects from a first location of the display screen to a second location of the display screen, wherein the signal is received based on user input at a second device external to the device;
removing display, by the device of the text or the image from the first location; and
displaying, by the device, the text or the image at the second location.

9. The computer-implemented method of claim 1, further comprising:
generating a recommendation, by the device, for another object for inclusion in the defined container, wherein the generating is based on a remaining space in the defined container once the one or more objects are placed in the defined container.

10. The computer-implemented method of claim 9, wherein the generating is further based on an occasion for which the one or more objects are selected.

11. The computer-implemented method of claim 9, wherein the generating is further based on a purchase history of a user that selected the one or more objects.

12. The computer-implemented method of claim 9, wherein the generating is further based on a use for the one or more objects.

13. A computer-based system comprising:
a memory that has stored thereon computer executable components; and
a processor that executes the following computer executable components stored in the memory:
an interface component configured to display a set of searchable products, wherein a subset of searchable products of the set of searchable products are capable of fitting within a set of sized containers;
a sorting component configured to organize the set of searchable products based on a set of user criteria;
a selection component configured to facilitate a selection of a first subset of searchable products of the set of searchable products based on a user preference;
a measuring component configured to identify a first sized container of the set of sized containers capable of fitting the first subset of searchable products within the first sized container; and
a presentation component configured to display a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.

14. The computer-based system of claim 13, wherein the set of user criteria comprises at least one of a product theme, a product price, or a product color.

15. The computer-based system of claim 13, further comprising a checkout component configured to facilitate a purchase of the first subset of searchable products, wherein the checkout component employs a shopping cart component to allow a user to conduct at least one of a set of tasks comprising a capability to continue purchasing additional products to add to the first subset of searchable products, add a second subset of searchable products fitting within another sized container for purchase, or complete a purchase of the first subset of searchable products.

16. The computer-based system of claim 15, wherein the checkout component is further configured to allow the user to add products from the set of searchable products to the checkout component, or add a card or a message to a first sized container associated with the first subset of searchable products.

17. The computer-based system of claim 13, further comprising:
a profile component configured to enable a user to access historical purchase information associated with previous product purchases of the set of searchable products; and
a curation component configured to facilitate a curation of a range of product types comprising at least one of candy items, clothing items, or designer drugstore items.

18. The computer-based system of claim 13, wherein the measuring component employs a determination component configured to determine a fit of the first sized container to the first subset of searchable products based on a weight of the first subset of searchable products and a corresponding value associated with the weight, and the computer-based system.

19. The computer-based system of claim 15, further comprising a suggestion component configured to suggest a product of the set of searchable products for the user to purchase based on the user preference.

20. A computer-readable storage medium storing executable instructions that, in response to execution, cause a device comprising a processor to perform operations, comprising:
displaying a set of searchable products, wherein a subset of searchable products of the set of searchable products are capable of fitting within a set of sized containers;
organizing the set of searchable products based on a set of user criteria;
selecting a first subset of searchable products of the set of searchable products based on a user preference;
identifying a first sized container of the set of sized containers capable of fitting the first subset of searchable products within the first sized container; and
displaying a set of options based on the first subset of searchable products, wherein the set of options comprise at least one of a list of purchasable photos to accompany the first subset of searchable products, a list of prices corresponding to the first subset of searchable products, or the set of sized containers for packaging the first subset of searchable products.
